(19) United States
(12) Patent Application Publication
(10) Pub. No.: US 2019/0179766 A1
(43) Pub. Date: Jun. 13, 2019

(54) TRANSLATION TABLE ENTRY PREFETCHING IN DYNAMIC BINARY TRANSLATION BASED PROCESSOR

(71) Applicant: Intel Corporation, Santa Clara, CA (US)

(72) Inventors: Girish Venkatasubramanian, Mountain View, CA (US); Jason M. Agron, San Jose, CA (US); Cristiano Pereira, Groveland, CA (US); Glenn Hinton, Portland, OR (US); Sebastian Winkel, Los Altos, CA (US); Rangeen Basu Roy Chowdhury, Santa Clara, CA (US)

(21) Appl. No.: 15/839,310

(22) Filed: Dec. 12, 2017

(51) Int. Cl. G06F 12/1009; G06F 12/1027; G06F 9/30

(52) U.S. Cl. CPC G06F 12/1009; G06F 12/1027; G06F 2212/657; G06F 2212/1021; G06F 9/3017

(57) ABSTRACT

A processor comprising an instruction execution circuit to execute a translated code generated based on a received code and a translation table (TT) controller circuit coupled to a translation table comprising a plurality of address mappings, wherein the TT controller circuit is to identify a trigger event associated with a physical memory page, determine, based on an identifier of the physical memory page, an entry in a manifest table, the entry comprising an address mapping between a first memory address within an address range comprising the physical memory page and a second memory address, and store the address mapping to the translation table.

### TECHNICAL FIELD

Embodiments of the disclosure relate generally to microprocessors and more specifically, but without limitation, to a dynamic binary translation (DBT) based microprocessor.

### BACKGROUND

Multi-core processors are found in most computing systems today, including servers, desktops and a System on a Chip (SoC). Computer systems that utilize these multi-core processors may execute instructions of various types of code.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a processing system according to an embodiment of the present disclosure.

FIG. 2 illustrates a manifest table according to an embodiment of the present disclosure.

FIG. 3 illustrates a process of IT entry prefetching based on an iTLB miss event according to an embodiment of the present disclosure.

FIG. 4 is a block diagram of a method 400 to prefetch T entries according to an embodiment of the present disclosure.

FIG. 5A is a block diagram illustrating a micro-architecture for a processor including heterogeneous core in which one embodiment of the disclosure may be used.

FIG. 5B is a block diagram illustrating an in-order pipeline and a register renaming stage, out-of-order issue/execution pipeline implemented according to at least one embodiment of the disclosure.

FIG. 6 illustrates a block diagram of the micro-architecture for a processor that includes logic in accordance with one embodiment of the disclosure.

FIG. 7 is a block diagram illustrating a system in which an embodiment of the disclosure may be used.

FIG. 8 is a block diagram of a system in which an embodiment of the disclosure may operate.

FIG. 9 is a block diagram of a system in which an embodiment of the disclosure may operate.

FIG. 10 is a block diagram of a System-on-a-Chip (SoC) in accordance with an embodiment of the present disclosure.

FIG. 11 is a block diagram of an embodiment of an SoC design in accordance with the present disclosure.

FIG. 12 illustrates a block diagram of one embodiment of a computer system.

### DETAILED DESCRIPTION

The code specified according to the instruction set architecture (ISA) of the processor is often translated into a translated code specified according to the same or another ISA. The translated code can be executed with improved performance (e.g., speed) at the cost of resources spent on the translation. Certain types of multi-core processors may include a binary translator that converts a code specified according to the instruction set architecture (ISA) of the processor to a functionality-equivalent version of the code (translated code) specified according to the same or another ISA. The code translation may include code optimization to the same ISA (e.g., to emulate a complex instruction using a set of simple instructions or to remove redundant instructions) or to another ISA. The translated code may be optimized with certain performance advantages such as, for example, the improvement of the execution speed. The optimization may include reordering of instructions.

The binary translator can be implemented using hardware circuitry or as a software component executed by the processor. In some implementations, the binary translator may use a translation table (TT) which is a hardware structure that the instruction fetch circuit can access with a minimum delay. The translation table may contain entries to store the mappings between the original code and the translated code. In some implementations, an entry of the translation table may contain the mapping between a first memory address referencing the memory location for storing the original code and a second memory address referencing the memory location for storing the translated code. The TT typically has a limited amount of storage space to store a pre-determined number of TT entries (e.g., 64 entries in a TT). Thus, the TT may store only a subset of address mappings, while the full set of mappings may be stored in another larger but slower storage device (e.g., in a far memory).

The processor may include a control circuit (referred to as TT control logic herein) to identify the translated code based on the mapping between the original code and the translated code. The TT control logic may identify (e.g., by monitoring a program counter that stores the address of the next instructions to be executed), an instruction ready to be executed, where the instruction is associated with a memory address. Responsive to identifying the instruction, the TT control logic may first look up the TT to determine whether the translation table includes an entry associated with the memory address. Responsive to determining that there is such a mapping (referred to as a TT hit), the TT control logic may cause the instruction execution unit to retrieve translated code, based on the mapping from the memory and execute the translated code. Responsive to determining that there is no such a mapping (referred to as a TT miss), the TT control logic may perform one of two fallback options. As one option, the TT control logic may assume that there is no translated code corresponding to the instruction to be executed, and allow the instruction execution unit to execute the code without translation (the original code). Alternatively, responsive to a TT miss, the TT control logic may look up the full set of mappings stored in the memory to determine whether there is translated code matching to the instruction to be executed in the full set. If the mapping to the translated code is found in the full set of mappings, an entry including the discovered mapping is added to the translation table, and the instruction execution unit is to execute the translated code. Because of the slow lookup using the full set of mappings, it is also desirable to move the entry into the TT prior to the TT miss.

Due to the limited size of the TT, the addition of the new entry may force the eviction of an existing entry in the translation table because the translation table may have been filled up by existing entries. In some implementations, the TT control logic selects the entry to evict base on a cache replacement policy (e.g., the least recently used (LRU) policy, which involves the eviction of the least recently used TT entry).

The performance of a binary translation based processor can be measured in terms of the ratio (referred to as the coverage) of executed instructions in translated code over those in un-translated code. Thus, the higher coverage value indicates a higher performance of the binary translation based processor. The TT entries may include one or more attribute values. The trigger event may occur due to a read miss associated with a memory page. The manifest table may contain TT entries that can be identified by their association with physical page numbers. Responsive to detecting the trigger event associated with the memory page identified by a physical page number, the TT prefetcher may prefetch these entries into the translation table in anticipation that they may be used for code translation, thus increasing the coverage (i.e., the TT hit rate) and reducing the need for searching the full set of mappings stored in the memory.

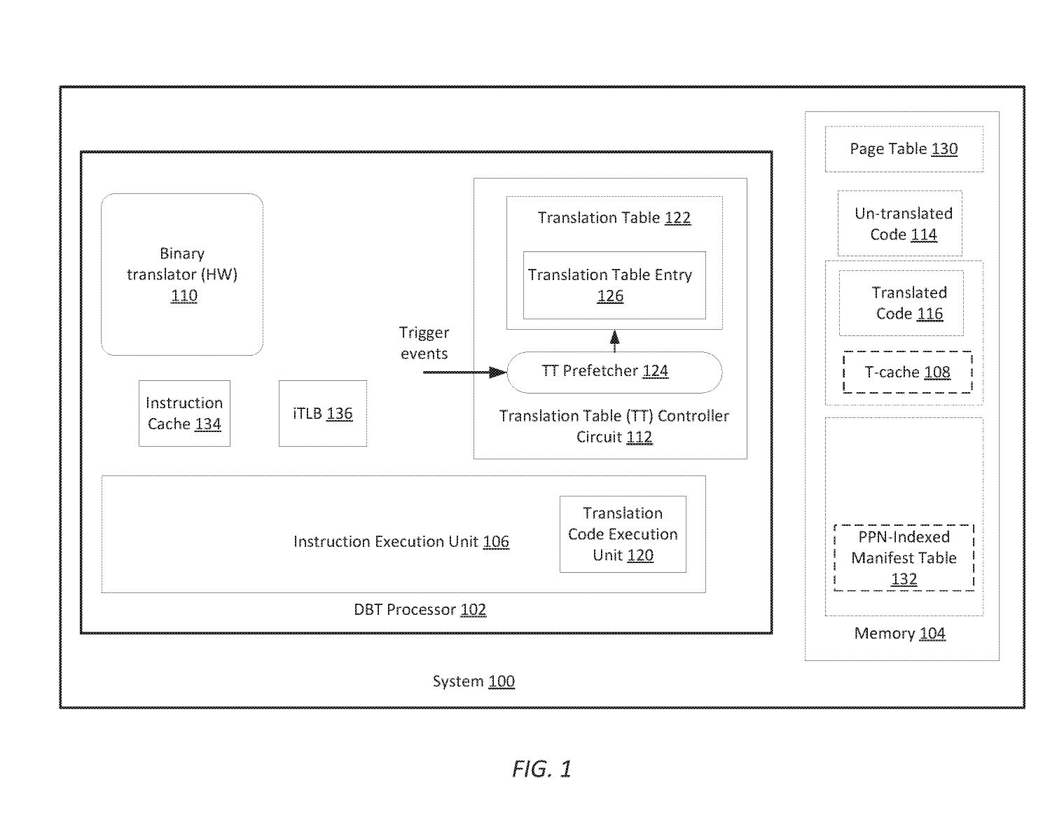

FIG. 1 illustrates a processing system 100 according to an embodiment of the present disclosure. As shown in FIG. 1, processing system 100 (e.g., a system-on-a-chip (SOC) or a motherboard of a computer system) may include a processor 102 and a memory device 104 communicatively coupled to processor 102. Processor 102 may be a hardware processing device such as, for example, a central processing unit (CPU) or a graphic processing unit (GPU) that includes one or more processing cores to execute software applications. Processing system 100 may further include a memory 104 for storing instructions and/or data associated with the execution of these instructions.

In one embodiment, processor 102 is a binary translator based processor that may execute code specified according to the ISA of the processor or may execute translated code (converted from the code) specified according to the same ISA or another ISA. As shown in FIG. 1, binary translation (BT) based processor 102 may include an instruction execution unit 106, a binary translator 110, and a translation table (TT) controller circuit 112 that are operably coupled to either other. Instruction execution unit 106 can be a processing core including circuit to execute both translated code and the un-translated code. For example, instruction execution unit 106 may include an un-translated code execution logic for executing the un-translated code and a translated code execution logic for executing the translated code.

Memory 104 may include a first region to store un-translated code 114 and a translation cache (or T-cache) region 108 to store translated code 116. Un-translated code 114 may include one or more instructions that can be referenced according to the memory address (e.g., physical memory addresses) at which an instruction is stored. In one embodiment, binary translator 110 may select, based on the need for optimization, regions of un-translated code 114 (also referred to as received code) and convert the received code to translated code 116. Similarly, one or more instructions of the translated code 116 may be referenced according to the memory address of the instruction in the translated code 116. In one embodiment, translated code 116 is stored in a memory segment referred to as translation cache (TC), where the translated code 116 is identified by the entry point (e.g., the memory address of the code block at which the region starts). For example, the entry point of the un-translated code can be stored at a memory address of 0xBA8F. The code block starting from 0xBA8F may be translated and stored in TC at 0xDE79BA8F. From the point onward, the TT controller circuit 112 may identify instructions whose memory address is in a program counter (not shown), indicating that these instructions are ready to be executed. The TT controller circuit 112 may first determine, based on the translation table 122, whether the instructions starting from the memory address (e.g., 0xBA8F) have corresponding translated code stored in a different memory location. If the translated code is found (e.g., at 0xBA8F), the translated code execution unit is to execute the translated code rather than the un-translated code.

Binary translator 110 can be a hardware-implemented circuit (or alternatively, a software component executing on processor 102) for converting regions of un-translated code 114 to translated code 116 stored in the TC. In some implementations, the conversion of regions of un-translated code to translated code is carried out (e.g., during code compilation) prior to loading the un-translated code 114 for execution. This is referred to as static binary translation. Embodiments of the present disclosure utilize dynamic binary translation, where the un-translated code is translated based on whether certain conditions are met during the execution process.

In one embodiment, instruction execution unit 106 may execute, without translation, un-translated code 114. Responsive to determining that a certain region of the un-translated code 114 has been executed a number of times (e.g., over a threshold value), the region is determined to be “hot” and worthy of translation. A hardware profiling logic (a combination of performance counters and branch profiling logic) may record the number of times or the “hotness” of a region. BT processor 102 may invoke binary translator 110 to select and translate the “hot” region for code optimization. In one embodiment, a code region corresponds to a control flow graph (CFG) region of the code which forms the basic unit on which the binary translator 110 can operate. Responsive to completing the translation, binary translator 110 may store the translated code 116 in the translation cache and store a mapping between the un-translated code 114 and the translated code 116 in an entry of a translation table. The mapping may be used in subsequent code execution to identify the translated code.

The code translation may be carried out using several rounds of optimizations from less optimized (thus requiring less translation time) to more optimized (thus requiring more translation time). In the first round of translation, the seminally translated code is less optimized. After executing the seminally translated code for a pre-determined number of times, the seminally translated code may be further translated (with further optimization) as processor 102 may determine with a higher confidence level that the code region is worthy investing more resources for further optimization (or further translation) because the region is used more often. This is referred to as geared translation. Each round of translation is colloquially associated with a gear level. The higher gear translations are typically more optimized than lower gear translations.

During the execution of code, translation table (TT) controller circuit 112 may determine, based on a translation table 122, whether a region of un-translated code 114 has a corresponding region of translated code that can be executed by translation code execution unit 120. In some implementations, the translation table 122 includes one or more entries to store the mappings between regions in un-translated code 114 and the corresponding regions of translated code 116 in the translation cache. For example, each entry may store the starting address of a code region in un-translated code 114 and the starting address of the corresponding region in translated code 108. Thus, IT controller circuit 112 may look up the translated code responding to identifying the un-translated code to be executed (e.g., in the program counter or the instruction pointer). Although these T entries may provide the mappings between regions of un-translated code 114 and translated code 116, the entries in the translation table are a subset of all mappings between the un-translated code regions and translated code regions. Thus, the entries in the translation table may not be the most useful for the upcoming translation request. Embodiments of the present disclosure provide IT prefetcher 124 that may prefetch entries from an intermediate data structure (referred to as a manifest table 132 stored in memory 104) into the translation table prior to their use for translation, thus improving the coverage of the translation table.

As shown in FIG. 1, IT controller circuit 112 may include a TT prefetcher 124 to prefetch, based on trigger events, TT entries from manifest table 132 stored in memory 104 into translation table 122. The manifest table 132 is a data structure that contains the physical page number (PPN) indexed data objects, where each PPN may uniquely identify a physical page in the physical memory space of the memory. Each of the PPN-index data objects may contain entries to store mappings between regions of un-translated code and regions of translated code associated with the physical page identified by the PPN. For example, the region of the un-translated code is associated with a physical page if the memory address of the entry point to the region falls within the physical page. TT prefetcher 124 may read manifest table 132 according to the PPN to identify translation mappings associated with the un-translated code in that physical page. The occurrence of a trigger event associated with a physical page may indicate the entries associated with the physical pages in manifest table 132 may likely be used for future translation request. T prefetcher 124 thus may prefetch, based on the PPN of the physical page, these entries into translation table 122 to improve the coverage (or TT hit rate) of processor 102.

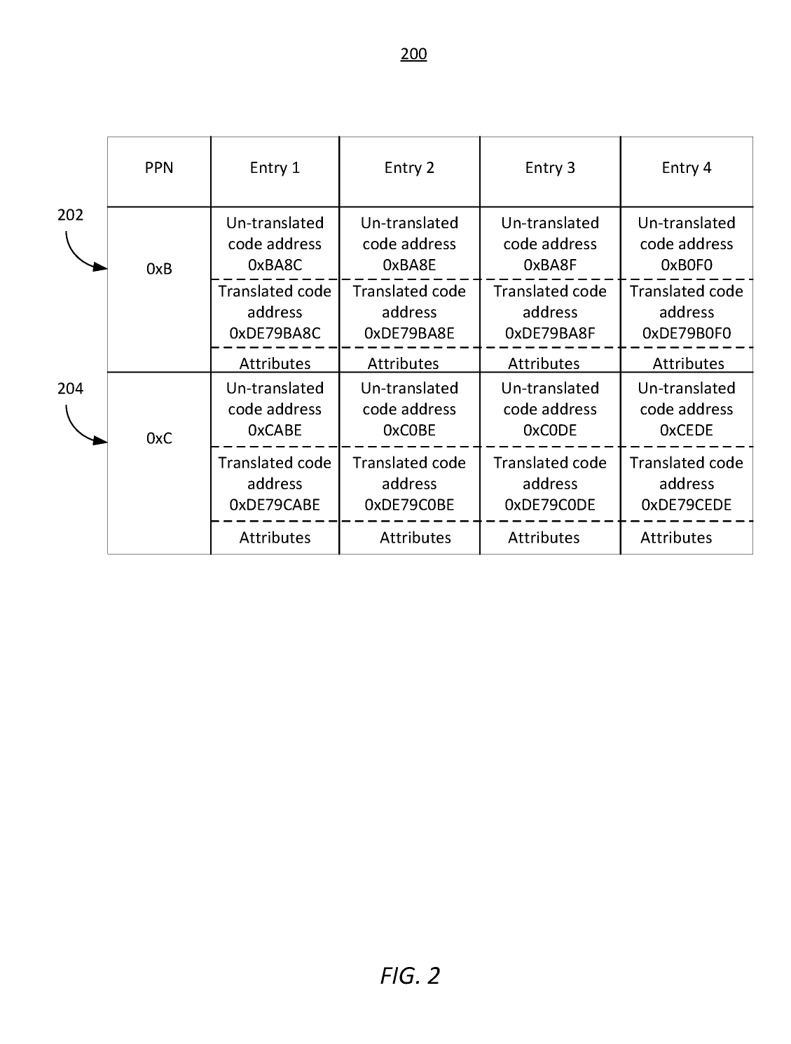

FIG. 2 illustrates a manifest table 200 according to an embodiment of the present disclosure. The manifest table may be stored in the memory 104. As shown in FIG. 2, manifest table 200 may include PPN-indexed data object 202, 204 to store mappings between un-translated code and translated code. As an example, data object 202 may be indexed to PPN 0xB, and data object 204 may be indexed to PPN 0xC. Data object 202 may contain the mapping entries (E1, E2, E3, E4) for un-translated code regions with their entry points in physical page 0xB, and data object 204 may contain the mapping entries (E1, E2, E3, E4) for un-translated code regions with their entry points in physical page 0xC.

In one embodiment, a data object of manifest table 200 may contain a subset of all translation mappings whose entry points are in the physical page identified by the PPN. The usage of only the selected translation mappings (rather than using the full list of mappings) can reduce the size and access latency of manifest table 200. The mapping entries stored in a data object 202, 204 may be selected based on certain attributes that may indicate the importance of an entry. For example, a code region that contains a loop is expected to be more optimized and thus gain more performance improvement over a code region without a loop. Thus, the mapping entries associated with loop code are prioritized over those not associated with loop code in manifest table 200. Other attributes that may be used to place an entry into translation table 122 may include the gear level (as higher gear translations are more optimized and thus gain more performance improvements over lower gear translations), the number of times that a translation has been executed (entries that have been used more times for translation are “hotter” and are prioritized for placement in the manifest). In one embodiment, each entry stored in the translation table 122 and entries in manifest table 200 may be associated with these attributes. Without loss of generality, in one embodiment, entries associated with translations whose gear levels are above a pre-determined threshold value are placed in translation table 122.

Referring to FIG. 1, in one embodiment, TT prefetcher 124 may detect a trigger event associated with a physical page (identified by a PPN) of a page table 130 that is used to translate the virtual memory address to a physical memory address at which an instruction is stored. Responsive to detecting the trigger event, TT prefetcher 124 may prefetch those entries associated with the PPN from manifest table 132 into translation table 122. The placement of these entries in translation table 122 prior to their usage helps improve the coverage (i.e., TT hit rate) of processor 102.

In one embodiment, the trigger event can be an instruction translation lookaside table (iTLB) miss associated with a physical page as explained in the following. As shown in FIG. 1, to speed up instruction execution, processor 102 may include an instruction cache 134 and an iTLB 136. The instruction cache 134 is a local storage of instructions that the instruction execution unit 106 has previously executed. The iTLB 136 is a memory cache to store recent virtual memory address to the physical memory address mapping used by the instruction execution unit 106 to execute an instruction. Memory 104 may further include a page table 130 which may store the memory address mappings between a virtual memory address space (used by instructions of software applications to address the memory) and the physical memory space (used by a memory controller to address the physical memory). Page table 130 may be organized according physical pages that are identified by their corresponding physical page numbers (PPNs). Each page of page table 130 may have a pre-determined size (e.g., 512 Bytes). A memory controller (not shown) may use the page table 130 to translate the virtual memory address of an instruction to its physical memory address and, based on the physical memory address, to retrieve the instruction. To speed up the future execution of the same instruction, within a process context, a front end circuit of the processor may store the mapping between the virtual memory address and the physical memory address for the instruction in iTLB 136. Further, instruction cache 134 may store a copy of the instruction. Thus, the local copy of the instruction in instruction cache and the local copy of the virtual to physical memory address mapping in iTLB 136 can help speed up future executions of the instruction that had been previously executed.

Each time instruction execution unit 106 is to execute an un-translated code, the front end circuit may first determine whether the virtual memory address of the starting instruction of the un-translated code is associated with a mapping already in iTLB 136 before performing a page walk in page table 130. If the virtual memory address to physical memory address mapping is found in iTLB 136 (referred to as an iTLB hit), instruction execution unit 106 may use the corresponding instruction already stored in instruction cache 134 for execution. If the virtual memory address to physical memory address mapping is not found in iTLB 136 (referred to as an iTLB miss), the memory controller may need to perform the page walk in page table 130 to determine the virtual memory address to physical memory address mapping. The page walk may include traversal of physical pages in page table 130.

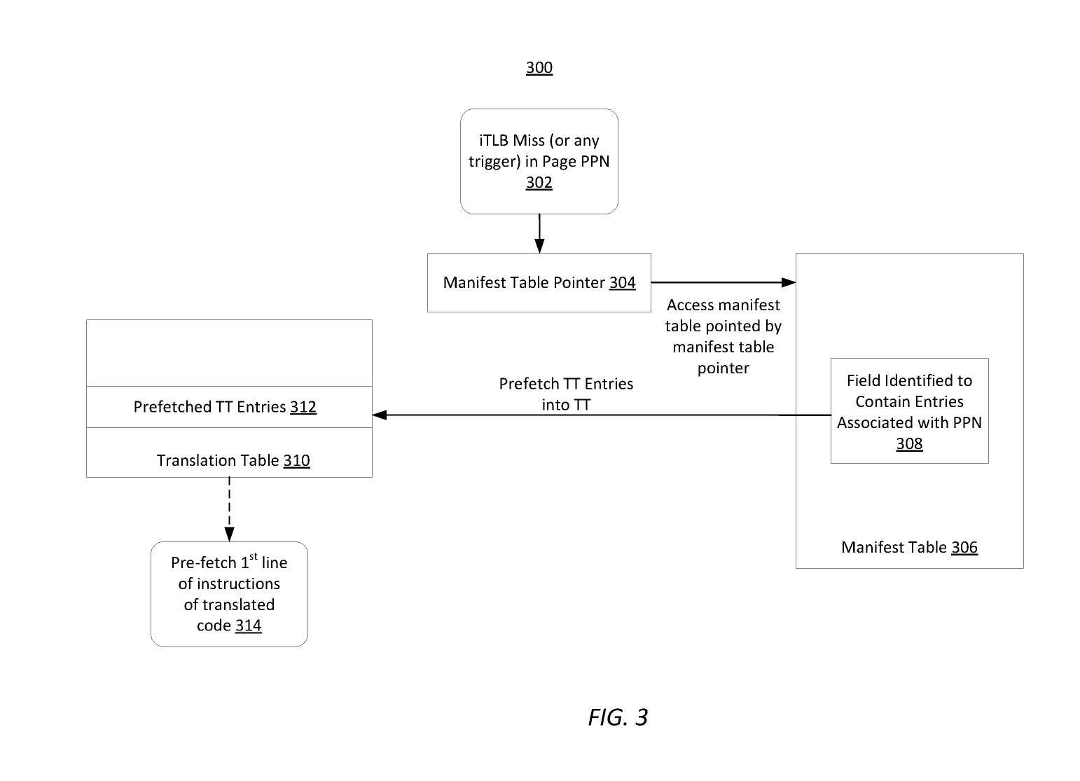

In one embodiment, the iTLB miss event may serve as a trigger event to start translation table prefetch. Responsive to detecting an iTLB miss event associated with a physical page identified by a PPN, IT prefetcher 124 may identify the data object containing entries associated with the PPN in manifest table 132 and copy these entries to translation table 122. FIG. 3 illustrates a process 300 of TT entry prefetching based on an iTLB miss event (or any triggering event) according to an embodiment of the present disclosure. At 302, an iTLB miss event associated with a physical page identified by a PPN in page table 130 may occur. Responsive to the iTLB miss event, the memory controller associated with processor 102 may perform a page walk in page table 130 to locate the physical page that contains the requested address mapping between the virtual memory address to the physical memory address. A front end circuit may place, based on the address mapping, in instruction cache 134 and provide the address mapping to iTLB 136, in addition to allow instruction execution unit 106 to execute the instruction.

The memory controller may also notify IT prefetcher 124 of the physical page number (PPN) associated with the physical page identified by the page walk. In one embodiment, TLB misses and page walks are architecturally visible to the instruction execution pipeline of the processor. When the TLB misses signal TT prefetcher 124 to install a new entry, the TT prefetcher may also begin a manifest table page walk using the same PPN used in the page walk. In one embodiment, the memory controller may store the PPN in a register and send a notification (e.g., via an interrupt) to TT prefetcher 124 about the availability of the PPN in the register.

Responsive to receiving the PPN, IT prefetcher 124 may access manifest table 306 and search through data objects in manifest table 306 to identify the data objects containing entries associated with the PPN. In one embodiment, the access to the manifest table 306 may be based on a manifest table pointer 304 stored in another register (e.g., a a register controlled by DBT processor (e.g., CR_MANIFEST_PTR) or a pre-specified memory location). The manifest table pointer 304 may point to the entry point of manifest table 306 stored in the memory 104. The entry point may point to the first data object in manifest table 306 from which the traversal of data objects may start.

IT prefetcher 124 may search through data objects in manifest table 306 to identify one or more data objects containing entries associated with the PPN generated from the iTLB miss event. IT prefetcher 124 may then prefetch these entries into translation table 310 and store these entries as prefetched entries 312. In one embodiment, prior to placing these entries in translation table 310, the IT prefetcher 124 may first determine whether the TT storing translation table 310 has enough free space to accommodate all the prefetched entries. Responsive to determining that the IT has enough free space, IT prefetcher 124 may store all these prefetched entries in entries 312. Responsive to determining that the IT does not have enough free space, IT prefetcher 124 may store a subset of all these prefetched entries to fill up the IT and discard the rest entries.

In one embodiment, IT prefetcher 124 may prefetch entries 312 during the same time period while the memory controller handles the iTLB miss (e.g., populating iTLB 136 and the instruction cache 134). Thus, the overhead associated with prefetching entries 312 may add only a minimum additional overhead to the already-existing overhead for handling iTLB miss.

In one further embodiment, based on the assumption that these prefetched entries 312 may be used IT controller circuit 112 for code translation very soon and that the translated code region associated with these entries may be executed by translated code execution unit of instruction execution unit 106, TT prefetcher 124 may also prefetch the instructions associated with the one or more prefetched entries to instruction cache 314 in anticipation that these instructions may be executed by the translated code execution unit of instruction execution unit 106 soon. In one embodiment, the number of instructions prefetched may fill up a first cache line of instruction cache 314. The prefetching of instructions in the instruction cache 314 may reduce the number of instruction cache misses, thereby further improving the performance of processor 102. In one embodiment, IT controller circuit 112 may prune the translation table 310 based on certain criteria to make free space available. For example, responsive to determining that a TT entry in translation table 310 has not have a TT hit over a pre-determined time (or a pre-determined clock cycles), IT controller circuit 112 may label the IT entry as available to receive a prefetched entry.

Other events also may be used to trigger the prefetching of entries in the manifest table. For example, in one embodiment, the page crossing event may serve as a trigger event for prefetching the entries associated with the just entered page. A page crossing happens when the program counter (or instruction pointer) flows from one page identified by a first PPN to another page identified by a second PPN (i.e., jumping or falling from one page to another). On the page crossing, the PPN has changed. In one embodiment, the processor may include a page crossing detection circuit (e.g., using an XOR) to trigger a manifest walk when a PPN number change is identified. In another embodiment, to reduce the frequency of manifest walks, a counter may be used to count the number of page crossings and trigger the manifest walk if the counter value exceeds a threshold value.

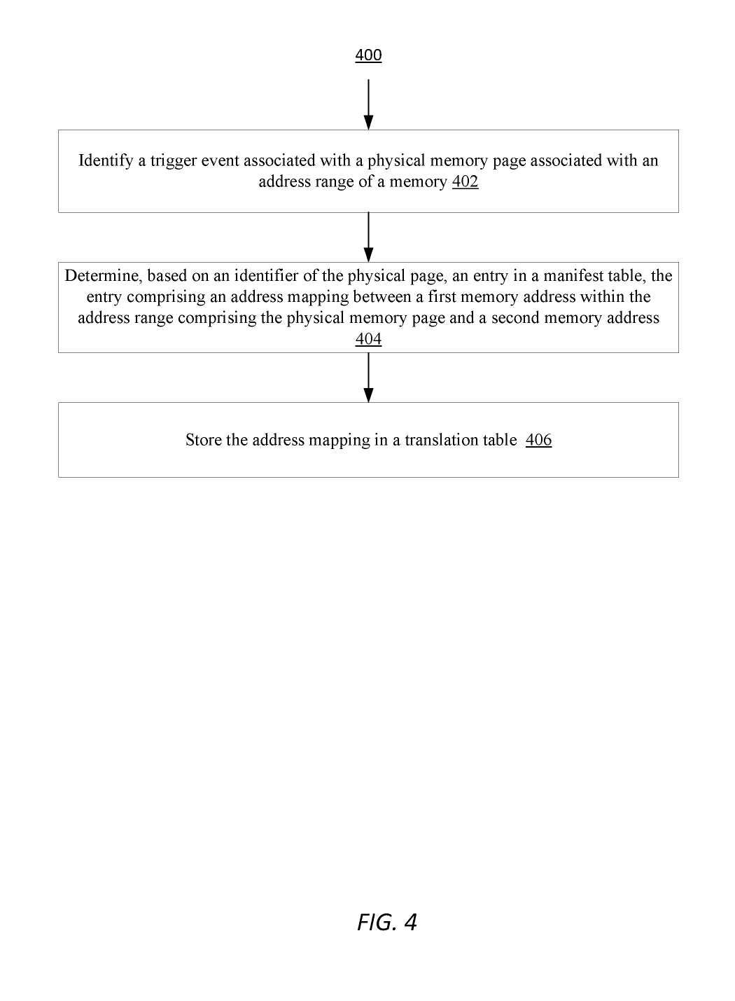

FIG. 4 is a block diagram of a method 400 to prefetch TT entries according to an embodiment of the present disclosure. Method 400 may be performed by processing logic that may include hardware (e.g., circuitry, dedicated logic, programmable logic, microcode, etc.), software (such as instructions run on a processing device, a general purpose computer system, or a dedicated machine), firmware, or a combination thereof. In one embodiment, method 400 may be performed, in part, by processor 102 and TT controller circuit 112 including TT prefetcher 124, as shown in FIG. 1.

For simplicity of explanation, the method 400 is depicted and described as a series of acts. However, acts in accordance with this disclosure can occur in various orders and/or concurrently and with other acts not presented and described herein. Furthermore, not all illustrated acts may be performed to implement the method 400 in accordance with the disclosed subject matter. In addition, those skilled in the art will understand and appreciate that the method 400 could alternatively be represented as a series of interrelated states via a state diagram or events.

Referring to FIG. 4, the processor, at 402, may identify a trigger event associated with a physical memory page associated with an address range of a memory.

At 404, the processor may determine, based on an identifier of the physical page, an entry in a manifest table, the entry comprising an address mapping between a first memory address within the address range comprising the physical memory page and a second memory address.

At 406, processor may store the address mapping to a translation table.

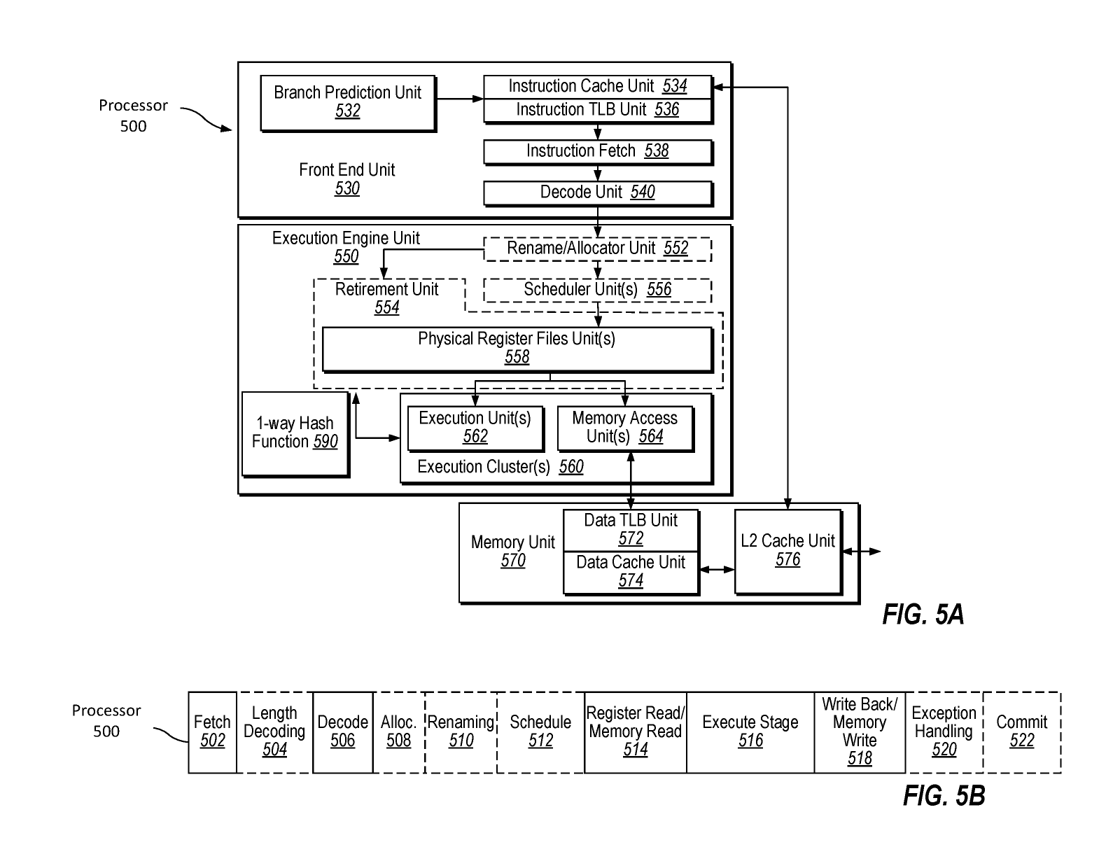

FIG. 5A is a block diagram illustrating a micro-architecture for a processor 500 that implements the processing device including heterogeneous cores in accordance with one embodiment of the disclosure. Specifically, processor 500 depicts an in-order architecture core and a register renaming logic, out-of-order issue/execution logic to be included in a processor according to at least one embodiment of the disclosure.

Processor 500 includes a front end unit 530 coupled to an execution engine unit 550, and both are coupled to a memory unit 570. The processor 500 may include a reduced instruction set computing (RISC) core, a complex instruction set computing (CISC) core, a very long instruction word (VLIW) core, or a hybrid or alternative core type. As yet another option, processor 500 may include a special-purpose core, such as, for example, a network or communication core, compression engine, graphics core, or the like. In one embodiment, processor 500 may be a multi-core processor or may part of a multi-processor system.

The front end unit 530 includes a branch prediction unit 532 coupled to an instruction cache unit 534, which is coupled to an instruction translation lookaside buffer (TLB) 536, which is coupled to an instruction fetch unit 538, which is coupled to a decode unit 540. The decode unit 540 (also known as a decoder) may decode instructions, and generate as an output one or more micro-operations, micro-code entry points, microinstructions, other instructions, or other control signals, which are decoded from, or which otherwise reflect, or are derived from, the original instructions. The decoder 540 may be implemented using various different mechanisms. Examples of suitable mechanisms include, but are not limited to, look-up tables, hardware implementations, programmable logic arrays (PLAs), microcode read only memories (ROMs), etc. The instruction cache unit 534 is further coupled to the memory unit 570. The decode unit 540 is coupled to a rename/allocator unit 552 in the execution engine unit 550.

The execution engine unit 550 includes the rename/allocator unit 552 coupled to a retirement unit 554 and a set of one or more scheduler unit(s) 556. The scheduler unit(s) 556 represents any number of different schedulers, including reservations stations (RS), central instruction window, etc. The scheduler unit(s) 556 is coupled to the physical register file(s) unit(s) 558. Each of the physical register file(s) units 558 represents one or more physical register files, different ones of which store one or more different data types, such as scalar integer, scalar floating point, packed integer, packed floating point, vector integer, vector floating point, etc., status (e.g., an instruction pointer that is the address of the next instruction to be executed), etc. The physical register file(s) unit(s) 558 is overlapped by the retirement unit 554 to illustrate various ways in which register renaming and out-of-order execution may be implemented (e.g., using a reorder buffer(s) and a retirement register file(s), using a future file(s), a history buffer(s), and a retirement register file(s); using a register maps and a pool of registers; etc.).

In one implementation, processor 500 may be the same as processor 102 described with respect to FIG. 1.

Generally, the architectural registers are visible from the outside of the processor or from a programmer's perspective. The registers are not limited to any known particular type of circuit. Various different types of registers are suitable as long as they are capable of storing and providing data as described herein. Examples of suitable registers include, but are not limited to, dedicated physical registers, dynamically allocated physical registers using register renaming, combinations of dedicated and dynamically allocated physical registers, etc. The retirement unit 554 and the physical register file(s) unit(s) 558 are coupled to the execution cluster(s) 560. The execution cluster(s) 560 includes a set of one or more execution units 562 and a set of one or more memory access units 564. The execution units 562 may perform various operations (e.g., shifts, addition, subtraction, multiplication) and operate on various types of data (e.g., scalar floating point, packed integer, packed floating point, vector integer, vector floating point).

While some embodiments may include a number of execution units dedicated to specific functions or sets of functions, other embodiments may include only one execution unit or multiple execution units that all perform all functions. The scheduler unit(s) 556, physical register file(s) unit(s) 558, and execution cluster(s) 560 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 564). It should also be understood that where separate pipelines are used, one or more of these pipelines may be out-of-order issue/execution and the rest in-order.

The set of memory access units 564 is coupled to the memory unit 570, which may include a data prefetcher 580, a data TLB unit 572, a data cache unit (DCU) 574, and a level 2 (L2) cache unit 576, to name a few examples. In some embodiments DCU 574 is also known as a first level data cache (L1 cache). The DCU 574 may handle multiple outstanding cache misses and continue to service incoming stores and loads. It also supports maintaining cache coherency. The data TLB unit 572 is a cache used to improve virtual address translation speed by mapping virtual and physical address spaces. In one exemplary embodiment, the memory access units 564 may include a load unit, a store address unit, and a store data unit, each of which is coupled to the data TLB unit 572 in the memory unit 570. The L2 cache unit 576 may be coupled to one or more other levels of cache and eventually to a main memory.

In one embodiment, the data prefetcher 580 speculatively loads/prefetches data to the DCU 574 by automatically predicting which data a program is about to consume. Prefeteching may refer to transferring data stored in one memory location of a memory hierarchy (e.g., lower level caches or memory) to a higher-level memory location that is closer (e.g., yields lower access latency) to the processor before the data is actually demanded by the processor. More specifically, prefetching may refer to the early retrieval of data from one of the lower level caches/memory to a data cache and/or prefetch buffer before the processor issues a demand for the specific data being returned.

The processor 500 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.).

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes a separate instruction and data cache units and a shared L2 cache unit, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

FIG. 5B is a block diagram illustrating an in-order pipeline and a register renaming stage, out-of-order issue/execution pipeline implemented by processor 500 of FIG. 5A according to some embodiments of the disclosure. The solid lined boxes in FIG. 5B illustrate an in-order pipeline, while the dashed lined boxes illustrates a register renaming, out-of-order issue/execution pipeline. In FIG. 5B, a processor 500 as a pipeline includes a fetch stage 502, a length decode stage 504, a decode stage 506, an allocation stage 508, a renaming stage 510, a scheduling (also known as a dispatch or issue) stage 512, a register read/memory read stage 514, an execute stage 516, a write back/memory write stage 518, an exception handling stage 522, and a commit stage 524. In some embodiments, the ordering of stages 502-524 may be different than illustrated and are not limited to the specific ordering shown in FIG. 5B.

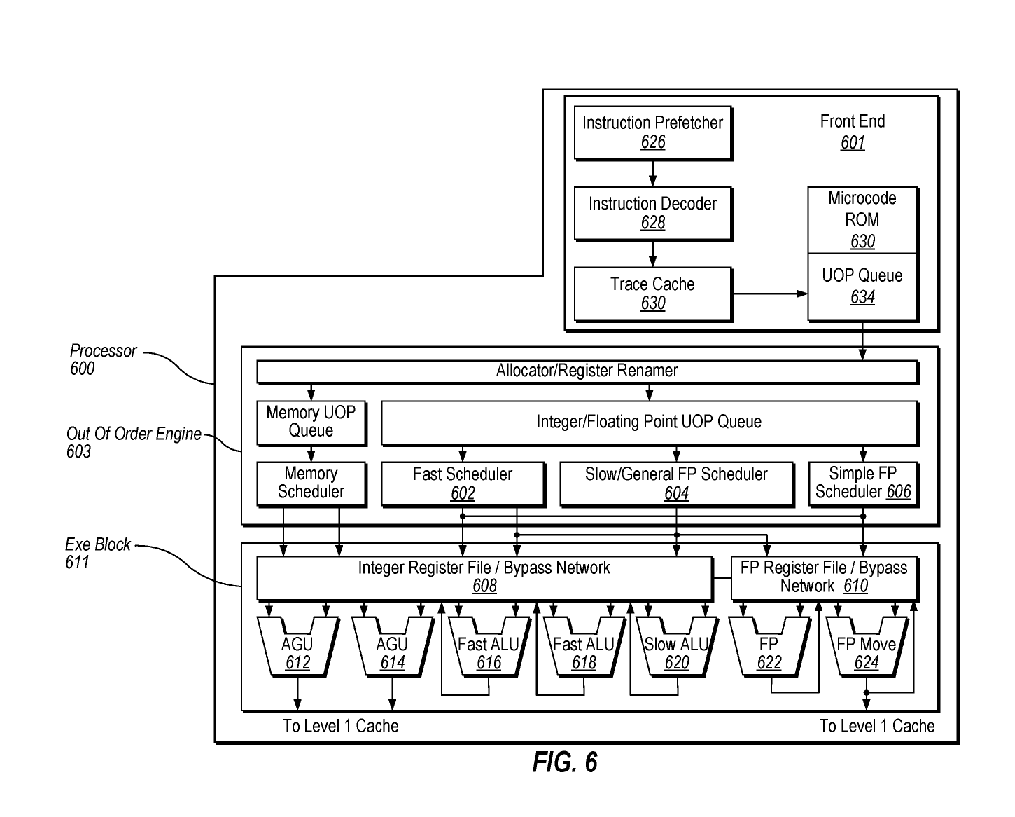

FIG. 6 illustrates a block diagram of the micro-architecture for a processor 600 that includes hybrid cores in accordance with one embodiment of the disclosure. In some embodiments, an instruction in accordance with one embodiment can be implemented to operate on data elements having sizes of byte, word, doubleword, quadword, etc., as well as datatypes, such as single and double precision integer and floating point datatypes. In one embodiment the in-order front end 601 is the part of the processor 600 that fetches instructions to be executed and prepares them to be used later in the processor pipeline.

The front end 601 may include several units. In one embodiment, the instruction prefetcher 626 fetches instructions from memory and feeds them to an instruction decoder 628 which in turn decodes or interprets them. For example, in one embodiment, the decoder decodes a received instruction into one or more operations called “micro-instructions” or “micro-operations” (also called micro op or uops) that the machine can execute. In other embodiments, the decoder parses the instruction into an opcode and corresponding data and control fields that are used by the micro-architecture to perform operations in accordance with one embodiment. In one embodiment, the trace cache 630 takes decoded uops and assembles them into program ordered sequences or traces in the uop queue 634 for execution. When the trace cache 630 encounters a complex instruction, the microcode ROM 632 provides the uops needed to complete the operation.

Some instructions are converted into a single micro-op, whereas others need several micro-ops to complete the full operation. In one embodiment, if more than four micro-ops are needed to complete an instruction, the decoder 628 accesses the microcode ROM 632 to do the instruction. For one embodiment, an instruction can be decoded into a small number of micro ops for processing at the instruction decoder 628. In another embodiment, an instruction can be stored within the microcode ROM 632 should a number of micro-ops be needed to accomplish the operation. The trace cache 630 refers to an entry point programmable logic array (PLA) to determine a correct micro-instruction pointer for reading the micro-code sequences to complete one or more instructions in accordance with one embodiment from the micro-code ROM 632. After the microcode ROM 632 finishes sequencing micro-ops for an instruction, the front end 601 of the machine resumes fetching micro-ops from the trace cache 630.

The out-of-order execution engine 603 is where the instructions are prepared for execution. The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 602, slow/general floating point scheduler 604, and simple floating point scheduler 606. The uop schedulers 602, 604, 606, determine when a uop is ready to execute based on the readiness of their dependent input register operand sources and the availability of the execution resources the uops need to complete their operation. The fast scheduler 602 of one embodiment can schedule on each half of the main clock cycle while the other schedulers can only schedule once per main processor clock cycle. The schedulers arbitrate for the dispatch ports to schedule uops for execution.

Register files 608, 610, sit between the schedulers 602, 604, 606, and the execution units 612, 614, 616, 618, 620, 622, 624 in the execution block 611. There is a separate register file 608, 610, for integer and floating point operations, respectively. Each register file 608, 610, of one embodiment also includes a bypass network that can bypass or forward just completed results that have not yet been written into the register file to new dependent uops. The integer register file 608 and the floating point register file 610 are also capable of communicating data with the other. For one embodiment, the integer register file 608 is split into two separate register files, one register file for the low order 32 bits of data and a second register file for the high order 32 bits of data. The floating point register file 610 of one embodiment has 128 bit wide entries because floating point instructions typically have operands from 64 to 128 bits in width.

The execution block 611 contains the execution units 612, 614, 616, 618, 620, 622, 624, where the instructions are actually executed. This section includes the register files 608, 610, that store the integer and floating point data operand values that the micro-instructions need to execute. The processor 600 of one embodiment is comprised of a number of execution units: address generation unit (AGU) 612, AGU 614, fast ALU 616, fast ALU 618, slow ALU 620, floating point ALU 622, floating point move unit 624. For one embodiment, the floating point execution blocks 622, 624, execute floating point, MMX, SIMD, and SSE, or other operations. The floating point ALU 622 of one embodiment includes a 64 bit by 64 bit floating point divider to execute divide, square root, and remainder micro-ops. For embodiments of the present disclosure, instructions involving a floating point value may be handled with the floating point hardware.

In one embodiment, the ALU operations go to the high-speed ALU execution units 616, 618. The fast ALUs 616, 618, of one embodiment can execute fast operations with an effective latency of half a clock cycle. For one embodiment, most complex integer operations go to the slow ALU 620 as the slow ALU 620 includes integer execution hardware for long latency type of operations, such as a multiplier, shifts, flag logic, and branch processing. Memory load/store operations are executed by the AGUs 612, 614. For one embodiment, the integer ALUs 616, 618, 620, are described in the context of performing integer operations on 64 bit data operands. In alternative embodiments, the ALUs 616, 618, 620, can be implemented to support a variety of data bits including 16, 32, 128, 256, etc. Similarly, the floating point units 622, 624, can be implemented to support a range of operands having bits of various widths. For one embodiment, the floating point units 622, 624, can operate on 128 bits wide packed data operands in conjunction with SIMD and multimedia instructions.

In one embodiment, the uops schedulers 602, 604, 606, dispatch dependent operations before the parent load has finished executing. As uops are speculatively scheduled and executed in processor 600, the processor 600 also includes logic to handle memory misses. If a data load misses in the data cache, there can be dependent operations in flight in the pipeline that have left the scheduler with temporarily incorrect data. A replay mechanism tracks and re-executes instructions that use incorrect data. Only the dependent operations need to be replayed and the independent ones are allowed to complete. The schedulers and replay mechanism of one embodiment of a processor are also designed to catch instruction sequences for text string comparison operations.

The processor 600 also includes logic to implement store address prediction for memory disambiguation according to embodiments of the disclosure. In one embodiment, the execution block 611 of processor 600 may include a store address predictor (not shown) for implementing store address prediction for memory disambiguation.

The term “registers” may refer to the on-board processor storage locations that are used as part of instructions to identify operands. In other words, registers may be those that are usable from the outside of the processor (from a programmer's perspective). However, the registers of an embodiment should not be limited in meaning to a particular type of circuit. Rather, a register of an embodiment is capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one embodiment, integer registers store thirty-two bit integer data. A register file of one embodiment also contains eight multimedia SIMD registers for packed data.

For the discussions below, the registers are understood to be data registers designed to hold packed data, such as 64 bits wide MMXTM registers (also referred to as ‘mm’ registers in some instances) in microprocessors enabled with MMX technology from Intel Corporation of Santa Clara, Calif. These MMX registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) technology can also be used to hold such packed data operands. In one embodiment, in storing packed data and integer data, the registers do not need to differentiate between the two data types. In one embodiment, integer and floating point are either contained in the same register file or different register files. Furthermore, in one embodiment, floating point and integer data may be stored in different registers or the same registers.

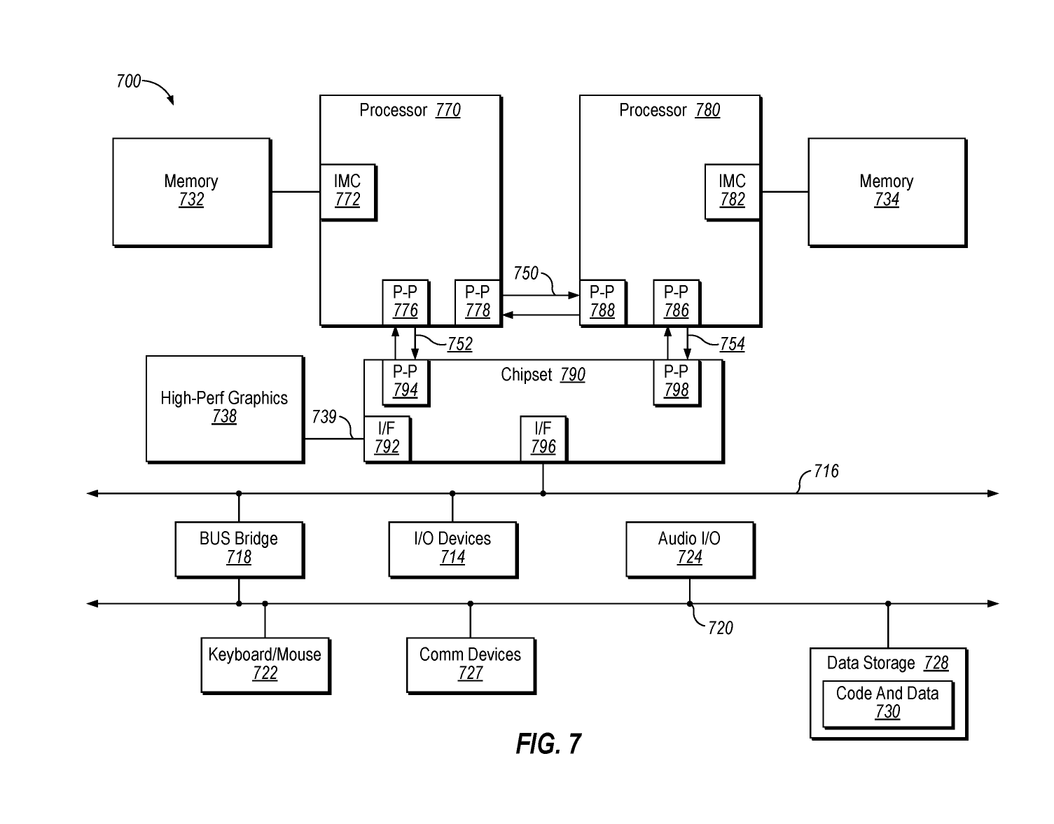

Referring now to FIG. 7, shown is a block diagram illustrating a system 700 in which an embodiment of the disclosure may be used. As shown in FIG. 7, multiprocessor system 700 is a point-to-point interconnect system, and includes a first processor 770 and a second processor 780 coupled via a point-to-point interconnect 750. While shown with only two processors 770, 780, it is to be understood that the scope of embodiments of the disclosure is not so limited. In other embodiments, one or more additional processors may be present in a given processor. In one embodiment, the multiprocessor system 700 may implement hybrid cores as described herein.

Processors 770 and 780 are shown including integrated memory controller units 772 and 782, respectively. Processor 770 also includes as part of its bus controller units point-to-point (P-P) interfaces 776 and 778; similarly, second processor 780 includes P-P interfaces 786 and 788. Processors 770, 780 may exchange information via a point-to-point (P-P) interface 750 using P-P interface circuits 778, 788. As shown in FIG. 7, IMCs 772 and 782 couple the processors to respective memories, namely a memory 732 and a memory 734, which may be portions of main memory locally attached to the respective processors.

Processors 770, 780 may each exchange information with a chipset 790 via individual P-P interfaces 752, 754 using point to point interface circuits 776, 794, 786, 798. Chipset 790 may also exchange information with a high-performance graphics circuit 738 via a high-performance graphics interface 739.

A shared cache (not shown) may be included in either processor or outside of both processors, yet connected with the processors via P-P interconnect, such that either or both processors' local cache information may be stored in the shared cache if a processor is placed into a low power mode.

Chipset 790 may be coupled to a first bus 716 via an interface 796. In one embodiment, first bus 716 may be a Peripheral Component Interconnect (PCI) bus, or a bus such as a PCI Express bus or another third generation I/O interconnect bus, although the scope of the present disclosure is not so limited.

As shown in FIG. 7, various I/O devices 714 may be coupled to first bus 716, along with a bus bridge 718 which couples first bus 716 to a second bus 720. In one embodiment, second bus 720 may be a low pin count (LPC) bus. Various devices may be coupled to second bus 720 including, for example, a keyboard and/or mouse 722, communication devices 727 and a storage unit 728 such as a disk drive or other mass storage device which may include instructions/code and data 730, in one embodiment. Further, an audio I/O 724 may be coupled to second bus 720. Note that other architectures are possible. For example, instead of the point-to-point architecture of FIG. 7, a system may implement a multi-drop bus or other such architecture.

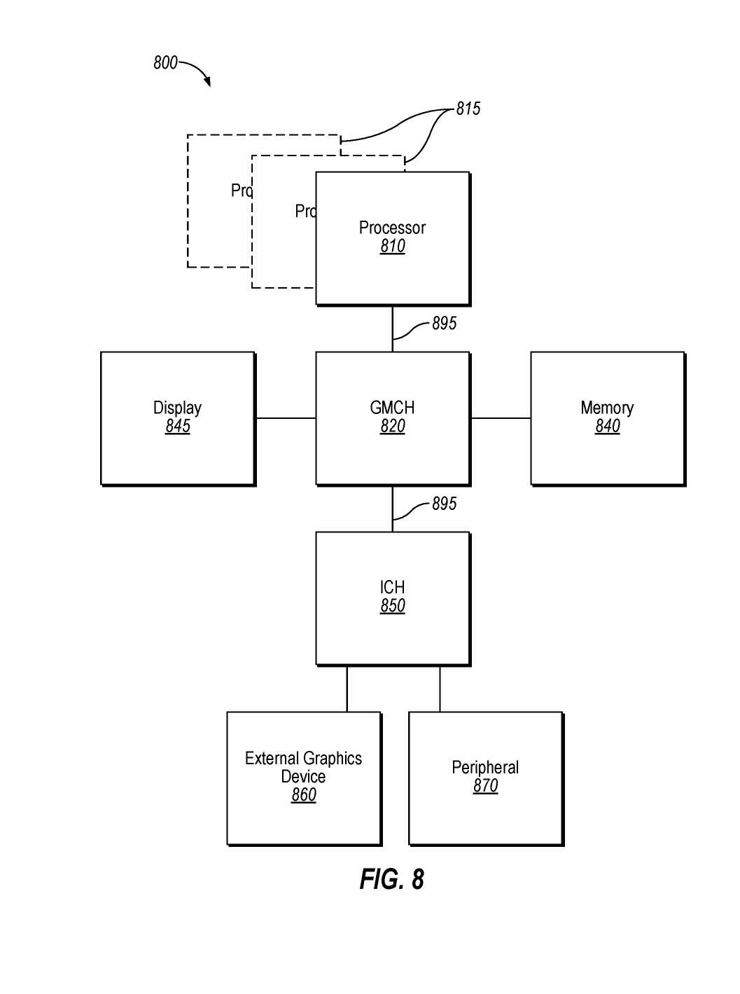

Referring now to FIG. 8, shown is a block diagram of a system 800 in which one embodiment of the disclosure may operate. The system 800 may include one or more processors 810, 815, which are coupled to graphics memory controller hub (GMCH) 820. The optional nature of additional processors 815 is denoted in FIG. 8 with broken lines. In one embodiment, processors 810, 815 implement hybrid cores according to embodiments of the disclosure.

Each processor 810, 815 may be some version of the circuit, integrated circuit, processor, and/or silicon integrated circuit as described above. However, it should be noted that it is unlikely that integrated graphics logic and integrated memory control units would exist in the processors 810, 815. FIG. 8 illustrates that the GMCH 820 may be coupled to a memory 840 that may be, for example, a dynamic random access memory (DRAM). The DRAM may, for at least one embodiment, be associated with a non-volatile cache.

The GMCH 820 may be a chipset, or a portion of a chipset. The GMCH 820 may communicate with the processor(s) 810, 815 and control interaction between the processor(s) 810, 815 and memory 840. The GMCH 820 may also act as an accelerated bus interface between the processor(s) 810, 815 and other elements of the system 800. For at least one embodiment, the GMCH 820 communicates with the processor(s) 810, 815 via a multi-drop bus, such as a frontside bus (FSB) 895.

Furthermore, GMCH 820 is coupled to a display 845 (such as a flat panel or touchscreen display). GMCH 820 may include an integrated graphics accelerator. GMCH 820 is further coupled to an input/output (I/O) controller hub (ICH) 850, which may be used to couple various peripheral devices to system 800. Shown for example in the embodiment of FIG. 8 is an external graphics device 860, which may be a discrete graphics device, coupled to ICH 850, along with another peripheral device 870.

Alternatively, additional or different processors may also be present in the system 800. For example, additional processor(s) 815 may include additional processors(s) that are the same as processor 810, additional processor(s) that are heterogeneous or asymmetric to processor 810, accelerators (such as, e.g., graphics accelerators or digital signal processing (DSP) units), field programmable gate arrays, or any other processor. There can be a variety of differences between the processor(s) 810, 815 in terms of a spectrum of metrics of merit including architectural, micro-architectural, thermal, power consumption characteristics, and the like. These differences may effectively manifest themselves as asymmetry and heterogeneity amongst the processors 810, 815. For at least one embodiment, the various processors 810, 815 may reside in the same die package.

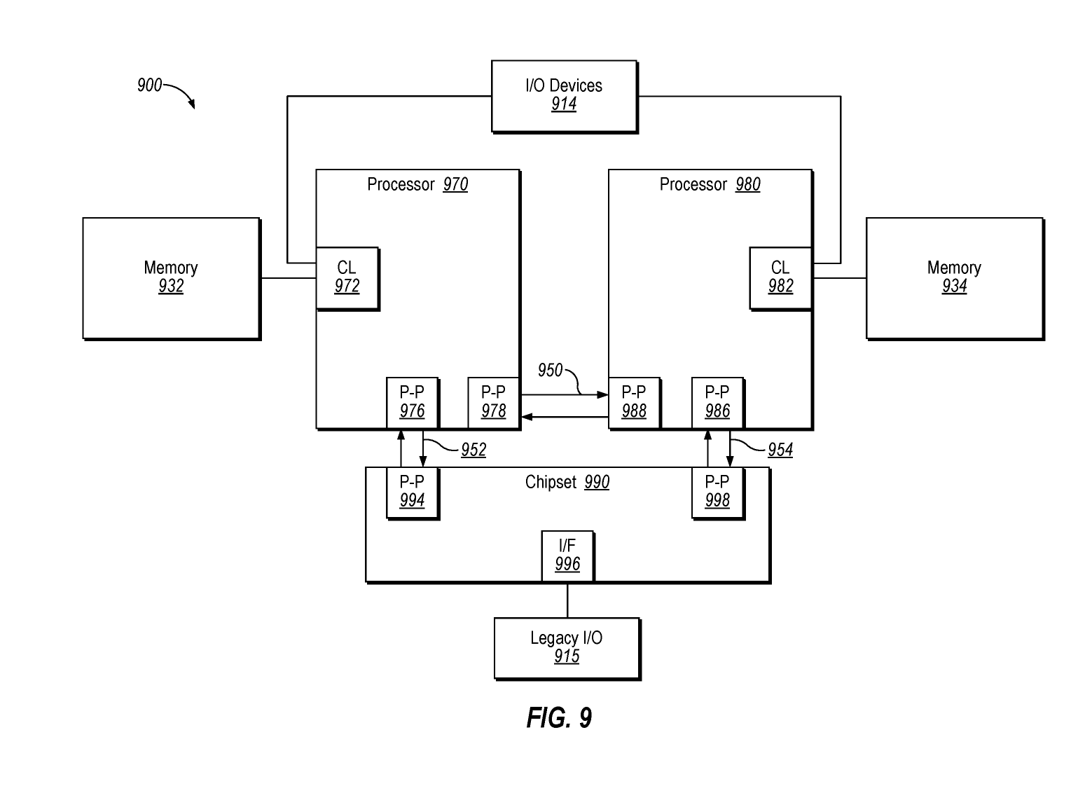

Referring now to FIG. 9, shown is a block diagram of a system 900 in which an embodiment of the disclosure may operate. FIG. 9 illustrates processors 970, 980. In one embodiment, processors 970, 980 may implement hybrid cores as described above. Processors 970, 980 may include integrated memory and I/O control logic (“CL”) 972 and 982, respectively and intercommunicate with each other via point-to-point interconnect 950 between point-to-point (P-P) interfaces 978 and 988 respectively. Processors 970, 980 each communicate with chipset 990 via point-to-point interconnects 952 and 954 through the respective P-P interfaces 976 to 994 and 986 to 998 as shown. For at least one embodiment, the CL 972, 982 may include integrated memory controller units. CLs 972, 982 may include I/O control logic. As depicted, memories 932, 934 coupled to CLs 972, 982 and I/O devices 914 are also coupled to the control logic 972, 982. Legacy I/O devices 915 are coupled to the chipset 990 via interface 996.

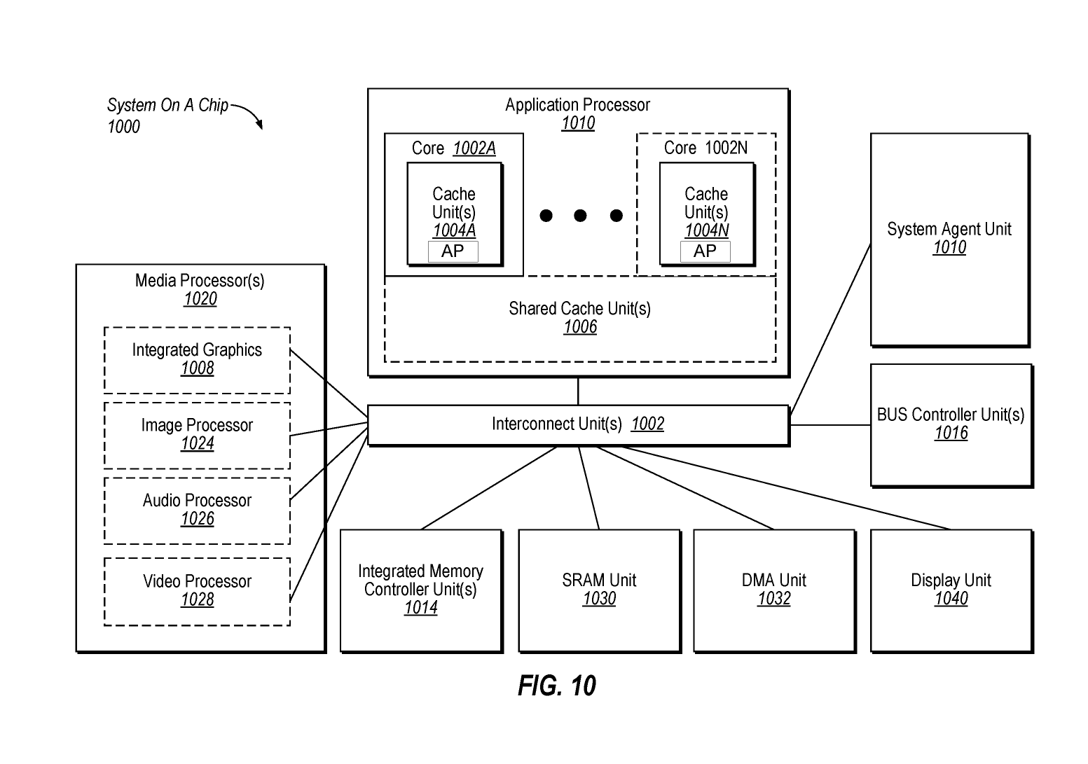

Embodiments may be implemented in many different system types. FIG. 10 is a block diagram of a SoC 1000 in accordance with an embodiment of the present disclosure. Dashed lined boxes are optional features on more advanced SoCs. In some implementations, SoC 1000 as shown in FIG. 10 includes features of the SoC 100 as shown in FIG. 1. In FIG. 10, an interconnect unit(s) 1012 is coupled to: an application processor 1020 which includes a set of one or more cores 1002A-N and shared cache unit(s) 1006; a system agent unit 1010; a bus controller unit(s) 1016; an integrated memory controller unit(s) 1014; a set or one or more media processors 1018 which may include integrated graphics logic 1008, an image processor 1024 for providing still and/or video camera functionality, an audio processor 1026 for providing hardware audio acceleration, and a video processor 1028 for providing video encode/decode acceleration; an static random access memory (SRAM) unit 1030; a direct memory access (DMA) unit 1032; and a display unit 1040 for coupling to one or more external displays. In one embodiment, a memory module may be included in the integrated memory controller unit(s) 1014. In another embodiment, the memory module may be included in one or more other components of the SoC 1000 that may be used to access and/or control a memory. The application processor 1020 may include a store address predictor for implementing hybrid cores as described in embodiments herein.

The memory hierarchy includes one or more levels of cache within the cores, a set or one or more shared cache units 1006, and external memory (not shown) coupled to the set of integrated memory controller units 1014. The set of shared cache units 1006 may include one or more mid-level caches, such as level 2 (L2), level 3 (L3), level 4 (L4), or other levels of cache, a last level cache (LLC), and/or combinations thereof.

In some embodiments, one or more of the cores 1002A-N are capable of multi-threading. The system agent 1010 includes those components coordinating and operating cores 1002A-N. The system agent unit 1010 may include for example a power control unit (PCU) and a display unit. The PCU may be or include logic and components needed for regulating the power state of the cores 1002A-N and the integrated graphics logic 1008. The display unit is for driving one or more externally connected displays.

The cores 1002A-N may be homogenous or heterogeneous in terms of architecture and/or instruction set. For example, some of the cores 1002A-N may be in order while others are out-of-order. As another example, two or more of the cores 1002A-N may be capable of execution the same instruction set, while others may be capable of executing only a subset of that instruction set or a different instruction set.

The application processor 1020 may be a general-purpose processor, such as a Core™ i3, i5, i7, 2 Duo and Quad, Xeon™, Itanium™, Atom™ or Quark™ processor, which are available from Intel™ Corporation, of Santa Clara, Calif. Alternatively, the application processor 1020 may be from another company, such as ARM Holdings™, Ltd, MIPS™, etc. The application processor 1020 may be a special-purpose processor, such as, for example, a network or communication processor, compression engine, graphics processor, co-processor, embedded processor, or the like. The application processor 1020 may be implemented on one or more chips. The application processor 1020 may be a part of and/or may be implemented on one or more substrates using any of a number of process technologies, such as, for example, BiCMOS, CMOS, or NMOS.

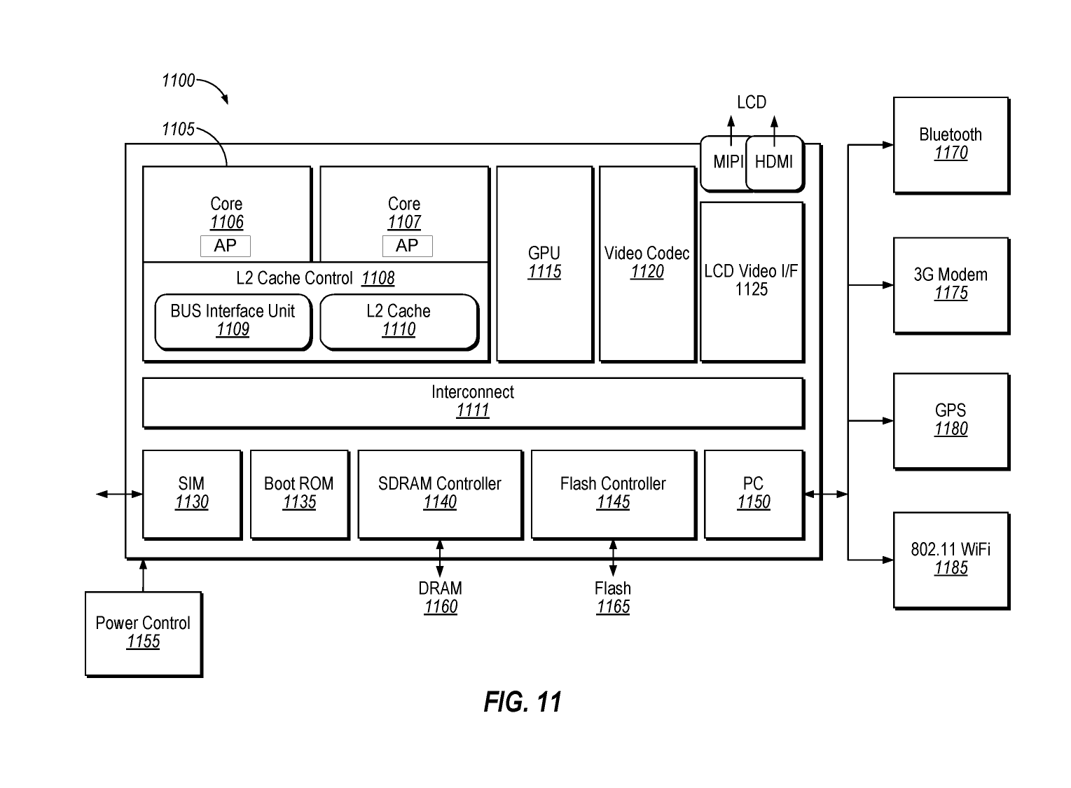

FIG. 11 is a block diagram of an embodiment of a system on-chip (SoC) design in accordance with the present disclosure. As a specific illustrative example, SoC 1100 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 1100 includes 2 cores—1106 and 1107. Cores 1106 and 1107 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 1106 and 1107 are coupled to cache control 1108 that is associated with bus interface unit 1109 and L2 cache 1110 to communicate with other parts of system 1100. Interconnect 1110 includes an on-chip interconnect, such as an IOSF, AMBA, or other interconnect discussed above, which potentially implements one or more aspects of the described disclosure. In one embodiment, cores 1106, 1107 may implement hybrid cores as described in embodiments herein.

Interconnect 1110 provides communication channels to the other components, such as a Subscriber Identity Module (SIM) 1130 to interface with a SIM card, a boot ROM 1135 to hold boot code for execution by cores 1106 and 1107 to initialize and boot SoC 1100, a SDRAM controller 1140 to interface with external memory (e.g. DRAM 1160), a flash controller 1145 to interface with non-volatile memory (e.g. Flash 1165), a peripheral control 1150 (e.g. Serial Peripheral Interface) to interface with peripherals, video codecs 1120 and Video interface 1125 to display and receive input (e.g. touch enabled input), GPU 1115 to perform graphics related computations, etc. Any of these interfaces may incorporate aspects of the disclosure described herein. In addition, the system 1100 illustrates peripherals for communication, such as a Bluetooth module 1170, 3G modem 1175, GPS 1180, and Wi-Fi 1185.

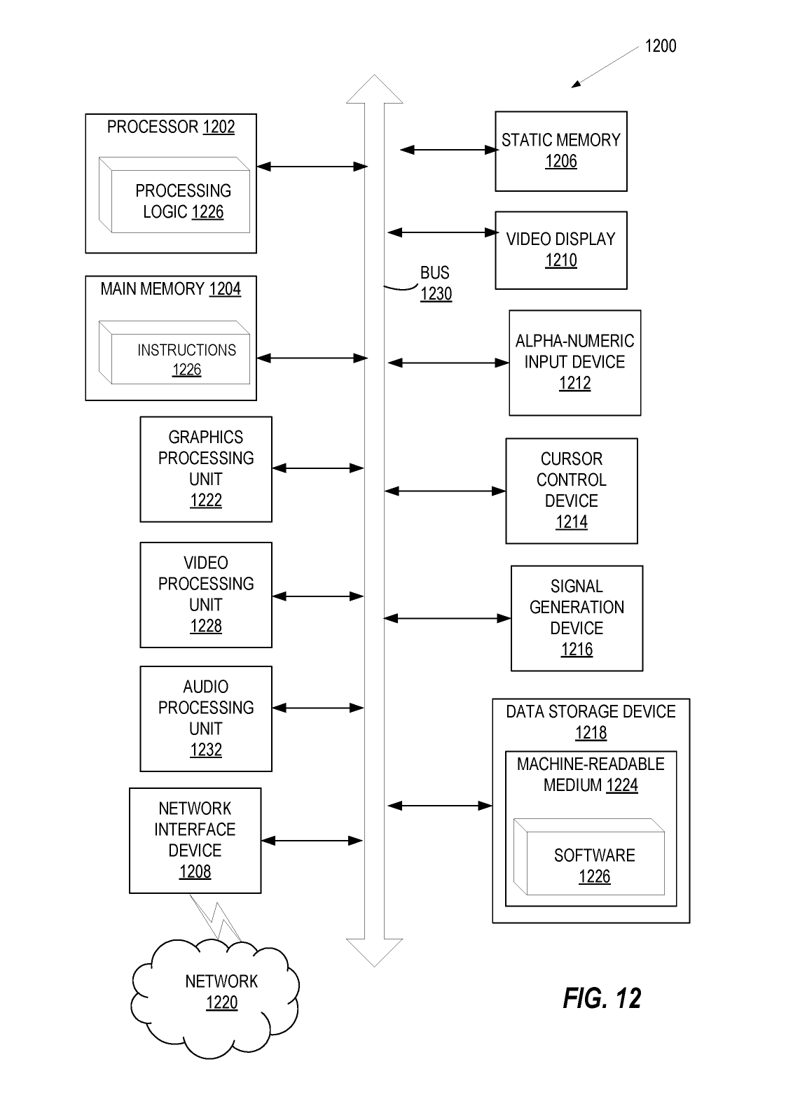

FIG. 12 illustrates a diagrammatic representation of a machine in the example form of a computer system 1200 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1200 includes a processing device 1202, a main memory 1204 (e.g., read-only memory (ROM), flash memory, dynamic random access memory (DRAM) (such as synchronous DRAM (SDRAM) or DRAM (RDRAM), etc.), a static memory 1206 (e.g., flash memory, static random access memory (SRAM), etc.), and a data storage device 1218, which communicate with each other via a bus 1230.

Processing device 1202 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1202 may also be one or more special-purpose processing devices such as an application specific integrated circuit (ASIC), a field programmable gate array (FPGA), a digital signal processor (DSP), network processor, or the like. In one embodiment, processing device 1202 may include one or more processing cores. The processing device 1202 is configured to execute the processing logic 1226 for performing the operations and steps discussed herein. For example, processing logic 1226 may perform operations as described in FIG. 4. In one embodiment, processing device 1202 is the same as processor architecture 102 described with respect to FIG. 1 as described herein with embodiments of the disclosure.

The computer system 1200 may further include a network interface device 1208 communicably coupled to a network 1220. The computer system 1200 also may include a video display unit 1210 (e.g., a liquid crystal display (LCD) or a cathode ray tube (CRT)), an alphanumeric input device 1212 (e.g., a keyboard), a cursor control device 1214 (e.g., a mouse), and a signal generation device 1216 (e.g., a speaker). Furthermore, computer system 1200 may include a graphics processing unit 1222, a video processing unit 1228, and an audio processing unit 1232.

The data storage device 1218 may include a machine-accessible storage medium 1224 on which is stored software 1226 implementing any one or more of the methodologies of functions described herein, such as implementing store address prediction for memory disambiguation as described above. The software 1226 may also reside, completely or at least partially, within the main memory 1204 as instructions 1226 and/or within the processing device 1202 as processing logic 1226 during execution thereof by the computer system 1200; the main memory 1204 and the processing device 1202 also constituting machine-accessible storage media.

The machine-readable storage medium 1224 may also be used to store instructions 1226 implementing store address prediction for hybrid cores such as described according to embodiments of the disclosure. While the machine-accessible storage medium 1128 is shown in an example embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the present disclosure. The term “machine-accessible storage medium” shall accordingly be taken to include, but not be limited to, solid-state memories, and optical and magnetic media.

The following examples pertain to further embodiments. Example 1 is a processor comprising an instruction execution circuit to execute a translated code generated based on a received code and a translation table (TT) controller circuit coupled to a translation table (TT) comprising a plurality of address mappings, wherein the IT controller is to identify a trigger event associated with a physical memory page, determine, based on an identifier of the physical memory page, an entry in a manifest table, the entry comprising an address mapping between a first memory address within an address range comprising the physical memory page and a second memory address, and store the address mapping to the translation table.

In Example 2, the subject matter of Example 1 can further include a binary translator circuit to translate the received code to the translated code, store the translated code in a memory, and store the address mapping as a T entry in the translation table.

In Example 3, the subject matter of Example 1 can further provide that the received code is specified according to a first instruction set architecture, and wherein the translated code is specified according to a second instruction set architecture.

In Example 4, the subject matter of Example 1 can further include an instruction translation lookaside buffer (iTLB) to store a mapping between a virtual memory address and a physical memory address, wherein the trigger event is an iTLB miss associated with the physical memory page.

In Example 5, the subject matter of Example 1 can further include a memory controller to responsive to a request to retrieve an instruction associated with a first virtual memory address, search an iTLB for a mapping associated with the first virtual memory address, and responsive to failing to identify the mapping associated with the first virtual memory address, perform a page walk in a page table to identify the physical memory page as a memory page containing a physical memory address mapped to the first virtual memory address, and generate the iTLB miss event associated with the physical memory page.

In Example 6, the subject matter of any of Examples 1 and 5 can further provide that responsive to identifying the physical memory address mapped to the first virtual memory address, the memory controller is to store the mapping between the first virtual memory address and the physical memory address in the iTLB.

In Example 7, the subject matter of Example 1 can further provide that the memory comprises a page table to store a plurality of mappings between virtual memory addresses and physical memory addresses, and wherein the trigger event is a page crossing event.

In Example 8, the subject matter of any of Examples 1 and 7 can further provide that the page crossing event is identified by a change of a physical page number associated with instructions to be executed.

In Example 9, the subject matter of Example 1 can further provide that the TT controller circuit is further to responsive to storing the address mapping to the translation table, prefetch an instruction associated with the second memory address into an instruction cache associated with the instruction execution circuit.

Example 10 is a system comprising a memory to store a manifest table comprising an entry identified by an identifier of a physical memory page of the memory, the entry comprising an address mapping between a first memory address within an address range comprising the physical memory page and a second memory address, a processor comprising an instruction execution circuit to execute a translated code generated based on a received code, and a translation table (TT) controller circuit coupled to a translation table comprising a plurality of address mappings, wherein the TT controller circuit is to identify a trigger event associated with the physical memory page, determine, based on the identifier of the physical memory page, the entry in the manifest table, and store the address mapping to the translation table.

In Example 11, the subject matter of Example 10 can further provide that the processor further comprises a binary translator circuit to translate the received code to the translated code, store the translated code in the memory, and store the address mapping as a TT entry in the translation table.

In Example 12, the subject matter of Example 10 can further provide that the received code is specified according to a first instruction set architecture, and wherein the translated code is specified according to a second instruction set architecture.

In Example 13, the subject matter of Example 10 can further provide that the processor further comprises an instruction translation lookaside buffer (iTLB) to store mappings between a virtual memory address and a physical memory address, wherein the trigger event is an iTLB miss associated with the physical memory page.

In Example 14, the subject matter of Example 10 can further provide that the processor further comprises a memory controller to responsive to a request to retrieve an instruction associated with a first virtual memory address, search an iTLB for a mapping associated with the first virtual memory address, and responsive to failing to identify the mapping associated with the first virtual memory address, perform a page walk in a page table to identify the physical memory page as a memory page containing a physical memory address mapped to the first virtual memory address, and generate the iTLB miss event associated with the physical memory page.

In Example 15, the subject matter of any of Examples 10 and 14 can further provide that responsive to identifying the physical memory address mapped to the first virtual memory address, the memory controller is to store the mapping between the first virtual memory address and the physical memory address in the iTLB.

In Example 16, the subject matter of Example 10 can further provide that the memory comprises a page table to store a plurality of mappings between virtual memory addresses and physical memory addresses, and wherein the trigger event is a page crossing event.

In Example 17, the subject matter of any of Examples 10 and 16 can further provide that the page crossing event is identified by a change of a physical page number associated with instructions to be executed.

In Example 18, the subject matter of Example 10 can further provide that the TT controller circuit is further to responsive to storing the address mapping to the translation table, prefetching an instruction associated with the second memory address into an instruction cache associated with the instruction execution circuit.

Example 19 is a method comprising identifying a trigger event associated with a physical memory page associated with an address range of a memory, determining, based on an identifier of the physical page, an entry in a manifest table, the entry comprising an address mapping between a first memory address within the address range comprising the physical memory page and a second memory address, and storing the address mapping in a translation table.

In Example 20, the subject matter of Example 19 can further include responsive to storing the address mapping to the translation table, storing an instruction associated with the second memory address into an instruction cache associated with the instruction execution circuit.

Example 21 is an apparatus comprising: means for performing the method of any of Examples 19 to 20.

Example 22 is a machine-readable non-transitory medium having stored thereon program code that, when executed, perform operations comprising identifying a trigger event associated with a physical memory page associated with an address range of a memory, determining, based on an identifier of the physical page, an entry in a manifest table, the entry comprising an address mapping between a first memory address within the address range comprising the physical memory page and a second memory address, and storing the address mapping in a translation table.

In Example 23, the subject matter of Example 22 can further provide that the operations further comprise responsive to storing the address mapping to the translation table, storing an instruction associated with the second memory address into an instruction cache associated with the instruction execution circuit.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and/or ‘operable to,’ in one embodiment, refers to some apparatus, logic, hardware, and/or element designed in such a way to enable use of the apparatus, logic, hardware, and/or element in a specified manner. Note as above that use of ‘to,’ ‘capable of/to,’ and/or ‘operable to,’ in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 910 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

1. A processor, comprising:
an instruction execution circuit to execute a translated code that is generated based on a received code; and
a translation table (TT) controller circuit coupled to a translation table comprising a plurality of address mappings, wherein the TT controller circuit is to:
identify a trigger event in response to attempted access of a physical memory page stored in a memory;
identify, based on an identifier of the physical memory page, an entry in a manifest table indexed to the physical memory page, the entry comprising an address mapping between a first memory address and a second memory address of the translated code, wherein the first memory address is within an address range comprising the physical memory page;
store the address mapping as a TT entry in the translation table; and
responsive to storage of the TT entry in the translation table, prefetch an instruction, which is to access data at the second memory address, into an instruction cache of the instruction execution circuit.

2. The processor of claim 1, further comprising a binary translator circuit coupled to the TT controller circuit, the binary translator circuit to:
translate the received code to the translated code; and
store the translated code in the memory at the second memory address.

3. The processor of claim 1, wherein the received code is specified according to a first instruction set architecture, and wherein the translated code is specified according to a second instruction set architecture.

4. The processor of claim 1, further comprising an instruction translation lookaside buffer (iTLB) to store a mapping between a virtual memory address and a physical memory address, wherein the trigger event is an iTLB miss associated with the physical memory page.

5. The processor of claim 1, further comprising a memory controller to:
responsive to a request to retrieve an instruction associated with a first virtual memory address, search an instruction translation lookaside buffer (iTLB) for a mapping associated with the first virtual memory address; and
responsive to failing to identify the mapping associated with the first virtual memory address:
perform a page walk in a page table to identify the physical memory page as a memory page containing a physical memory address mapped to the first virtual memory address; and
generate an iTLB miss event associated with the physical memory page.

6. The processor of claim 5, wherein responsive to identifying the physical memory address mapped to the first virtual memory address, the memory controller is to:
store the mapping between the first virtual memory address and the physical memory address in the iTLB.

7. The processor of claim 1, wherein the memory comprises a page table to store a plurality of mappings between virtual memory addresses and physical memory addresses, and wherein the trigger event is a page crossing event.

8. The processor of claim 7, wherein the page crossing event is identified by a change of a physical page number associated with instructions to be executed.

9. (canceled)

10. A system, comprising:
a memory to store a manifest table comprising an entry identified by an identifier of a physical memory page of the memory, the entry comprising an address mapping between a first memory address of received code and a second memory address of translated code, wherein the first memory address is within an address range comprising the physical memory page;
a processor comprising an instruction execution circuit to execute the translated code, which is generated based on the received code; and
a translation table (TT) controller circuit coupled to a translation table comprising a plurality of address mappings, wherein the TT controller circuit is to:
identify a trigger event in response to attempted access of the physical memory page stored in the memory;
identify, based on the identifier of the physical memory page, the entry in the manifest table indexed to the physical memory page;
store the address mapping as a TT entry in the translation table; and
responsive to storage of the TT entry in the translation table, prefetch an instruction, which is to access data at the second memory address, into an instruction cache of the instruction execution circuit.

11. The system of claim 10, wherein the processor further comprises a binary translator circuit coupled to the TT controller circuit, the binary translator circuit to:
translate the received code to the translated code; and
store the translated code in the memory at the second memory address.

12. The system of claim 10, wherein the received code is specified according to a first instruction set architecture, and wherein the translated code is specified according to a second instruction set architecture.

13. The system of claim 10, wherein the processor further comprises an instruction translation lookaside buffer (iTLB) to store mappings between a virtual memory address and a physical memory address, wherein the trigger event is an iTLB miss associated with the physical memory page.

14. The system of claim 10, wherein the processor further comprises:
a memory controller to:
responsive to a request to retrieve an instruction associated with a first virtual memory address, search an instruction translation lookaside buffer (iTLB) for a mapping associated with the first virtual memory address; and
responsive to failing to identify the mapping associated with the first virtual memory address:
perform a page walk in a page table to identify the physical memory page as a memory page containing a physical memory address mapped to the first virtual memory address; and
generate an iTLB miss event associated with the physical memory page.

15. The system of claim 14, wherein responsive to identifying the physical memory address mapped to the first virtual memory address, the memory controller is to store the mapping between the first virtual memory address and the physical memory address in the iTLB.

16. The system of claim 10, wherein the memory comprises a page table to store a plurality of mappings between virtual memory addresses and physical memory addresses, and wherein the trigger event is a page crossing event.

17. The system of claim 16, wherein the page crossing event is identified by a change of a physical page number associated with instructions to be executed.

18. (canceled)

19. A method comprising:
translating received code, by a processor, to generate translated code;
identifying, by a translation table (TT) controller circuit of the processor, a trigger event in response to attempted access of a physical memory page located within an address range of a memory;
identifying, by the TT controller circuit based on an identifier of the physical page, an entry in a manifest table indexed to the physical memory page, the entry comprising an address mapping between a first memory address of the received code and a second memory address of the translated code, wherein the first memory address is within the address range comprising the physical memory page;
storing, by the TT controller circuit, the address mapping as a TT entry in a translation table coupled to the TT controller circuit; and
responsive to storing the TT entry in the translation table, prefetching an instruction, which is to access data at the second memory address, into an instruction cache of the processor.

20. (canceled)

21. The method of claim 19, wherein the received code is specified according to a first instruction set architecture, and wherein the translated code is specified according to a second instruction set architecture.

22. The method of claim 19, further comprising storing, in an instruction translation lookaside buffer (iTLB), a mapping between a virtual memory address and a physical memory address, wherein the trigger event is an iTLB miss associated with the physical memory page.

23. The method of claim 19, further comprising:
responsive to a request to retrieve an instruction associated with a first virtual memory address, searching an instruction translation lookaside buffer (iTLB) for a mapping associated with the first virtual memory address; and
responsive to failing to identify the mapping associated with the first virtual memory address:
performing a page walk in a page table to identify the physical memory page as a memory page containing a physical memory address mapped to the first virtual memory address; and
generating an iTLB miss event associated with the physical memory page.
